(19) United States
(12) Patent Application Publication
(10) Pub. No.: US 2012/0057474 A1
(43) Pub. Date: Mar. 8, 2012

(54) METHOD AND APPARATUS FOR HANDOVER CONTROL IN A MOBILE COMMUNICATION SYSTEM WITH CSG

(75) Inventors: Jun Hirano, Kanagawa (JP); Hong Cheng, Singapore (SG); Tien Ming Benjamin Koh, Singapore (SG); Hong Tat Toh, Singapore (SG)

(73) Assignee: PANASONIC CORPORATION, Osaka (JP)

(21) Appl. No.: 13/318,924

(22) PCT Filed: Apr. 28, 2010
(86) PCT No.: PCT/JP2010/003049

§ 371 Date: Nov. 4, 2011

(30) Foreign Application Priority Data
May 8, 2009 (JP) 2009-113950

(51) Int. Cl. H04W 36/30

(52) U.S. Cl. 370/248

(57) ABSTRACT

Due to the coverage size of the CSG cell, handover to macro-cell may occur frequently. These handovers are not desirable to both the user and operators. However, to disable or delay the handover of the CSG Cell would cause UE experiencing radio link failure and not able to re-establish connection to other cells. The present invention introduces a method for the UE to increase the stickiness to the CSG cells based on the user preferences and application requirements. When applied, it keeps the UE to the CSG cell as long as possible and reduces the possibility of connection re-establishment failure. The invention is also applicable to the corporate network deployment with multiple CSG cells.

### TECHNICAL FIELD

This invention pertains to data communications network. More specifically, it relates to the handover control for the mobile terminal in a mobile communication system.

### BACKGROUND ART

With the advance of mobile communication, 3rd Generation Partnership Program (3GPP) introduced the concept of Closed Subscriber Group (CSG) cells in the following Non-patent Document 1 and Non-patent Document 2, which is usually deployed over the minimized access nodes, e.g. Home NodeB (HNB), or Home eNodeB (HeNB). The use of these minimized access nodes and the CSG concept allows mobile operators to extend their coverage or roll out new services at much faster speed and lower cost. For a user of the CSG, connecting via the CSG cell normally means reduced fees and additional services. Therefore, the CSG user generally prefers to stay in CSG cell as long as possible. This helps the mobile operator to reduce the load in the macro-cell network as well.

Due to the radio characteristics of the minimized access nodes, i.e. HNB and HeNB, CSG cells usually have limited transmission power and coverage size. When a User Equipment (UE) moves away from the center of a CSG cell, it may detect stronger radio signal from the adjacent or overlapping macro-cells. Normally, this would trigger the HNB or HeNB to initiate handover. However, this handover is not desirable for both the user and the operator. For example, if the UE is accessing the Local IP Access as defined in the Non-patent Document 2, handover to the macro-cell may cause service interruption. Therefore, to avoid the advert effects, the CSG cell should not initiate handover aggressively. Together with the small coverage size of the CSG cell, this would cause the UE experiencing radio link problem if it continues to move out, e.g. goes out of the CSG coverage without receiving the Handover Command from the HNB or HeNB.

Once the radio link problem is detected, the UE will follow the procedure defined in corresponding technology, e.g. RRC protocol as specified in the following Non-patent Document 3, to recover from the problem. However, as defined in the Non-patent Document 3, after the timer T310, the UE will perform the cell selection process as specified in the following Non-patent Document 4 and try to re-establish the connection in the selected cell. Because the cell selection process in the Non-patent Document 4 follows the best cell principle, the cell with stronger signal, i.e. the macro-cell, is most likely chosen. This would result in UE trying to perform RRC Re-establishment to the macro-cell. But, since the CSG cell did not initiate the handover, the macro-cell is not a prepared cell for the UE. Therefore, this re-establishment process will fail, and result in service interruption to the UE.

### CITATION LIST

### Non Patent Literature

[NPL 1] Service accessibility, 3GPP TS22.011 v8.6.0 Release 8, 2008-12, http://www.3gpp.org/ftp/Specs/archive/22_series/22.011/22011-860.zip
[NPL 2] Service requirements for Home NodeBs and Home eNodeBs, 3GPP TS22.220 v1.0.1 Release 9, 2008-12, http://www.3gpp.org/ftp/Specs/archive/22_series/22.220/22220-101.zip
[NPL 3] RRC Protocol Specification, 3GPP TS36.331 v8.4.0 Release 8, 2008-12, http://www.3gpp.org/ftp/Specs/archive/36_series/36.331/36331-840.zip
[NPL 4] UE procedures in IDLE mode, 3GPP TS36.304 v8.4.0 Release 8, 2008-12, http://www.3gpp.org/ftp/Specs/archive/36_series/36.304/36304-840.zip

### SUMMARY OF INVENTION

### Technical Problem

There are some potential solutions to the problem, e.g. extending the T310 to infinity, such that UE does not perform cell selection. But this would cause service interruption if a UE really moves out of the CSG coverage into the macro-cell. The other alternative is to configure the CSG cell to always prepare the macro-cells. However, this unnecessarily increases the burden of the macro-cell, since the UE may move back to the CSG cell. And, even if the UE successfully re-established the connection to macro-cell, the CSG specific service may be interrupted, e.g. the Local IP Access.

Based on above, it is obvious that a better solution to the problem is necessary.

It is an object of the invention to solve the above discussed problems. In particular, it aims to provide a method to avoid connection re-establishment failure while maximizing the UE's stickiness to the CSG cell.

Another object of the invention is to provide a method to decide the proper stickiness of the CSG cell based on user preference and application requirements.

### Solution to Problem

In its broadest aspect, this invention presents a system for the UE to decide on a stickiness of a CSG cell and enforce it in the CSG cell, such that the system can prepare other cells on time to allow the UE to re-establish connection.

In the preferred aspect, the UE can decide on the stickiness of the CSG cell based on the user preference and active application requirements.

In another preferred aspect, the HeNB or HNB only prepares non-sticky cells after the stickiness of the CSG cell expires.

In yet another preferred aspect, the UE can disable the stickiness mechanism.

In another preferred aspect, there can be multiple sticky cells.

In another preferred aspect, the UE has different stickiness settings for different CSG cells.

In another preferred aspect, the stickiness of the CSG cell depends on the operation mode of the base station.

In another preferred aspect, the stickiness setting also applies to cells of a HNB or HeNB operating in hybrid mode.

In another preferred aspect, the stickiness settings are applied to a CSG cell that is granted access through manual selection process.

### Advantageous Effects of Invention

This invention has the advantage of solving the prior art's problems. Specifically, this invention has the advantage of avoiding connection re-establishment failure while maximizing the UE's stickiness to the CSG cell. Furthermore, this invention also has the advantage of deciding the proper stickiness of the CSG cell based on user preference and application requirements.

### BRIEF DESCRIPTION OF DRAWINGS

FIG. 1 presents a network architecture example which can be applied to the present invention.

FIG. 2 presents an example operation sequence of the present invention in the network architecture shown in FIG. 1.

FIG. 3 presents an alternative operation sequence of the present invention with different stickiness configuration.

FIG. 4 presents an example architecture of the User Equipment (UE) that implements the present invention.

FIG. 5 presents an example logic that can be employed by the UE.

FIG. 6 presents an example architecture of the Home eNode B (HeNB) that implements the present invention.

FIG. 7 presents an example logic that can be employed by the HeNB.

FIG. 8 presents an alternative network architecture which can be applied to the present invention.

FIG. 9 presents an example operation sequence of the present invention when applied to the network architecture shown in FIG. 8.

### DESCRIPTION OF EMBODIMENTS

In the following description, for the purpose of explanation, specific numbers, times, structures, protocols, and other parameters are set forth in order to provide a thorough understanding of the present invention. However, it will be apparent to anyone skilled in the art that the present invention may be practiced without these specific details.

In the following description, for the purpose of explanation, the 3GPP Long Term Evolution (LTE) is used as example access technology. However, it will be apparent to anyone skilled in the art that the present invention may be practiced with other access technology under the same principle, e.g. UMTS, WiMAX, or LTE Advanced.

### Embodiment 1

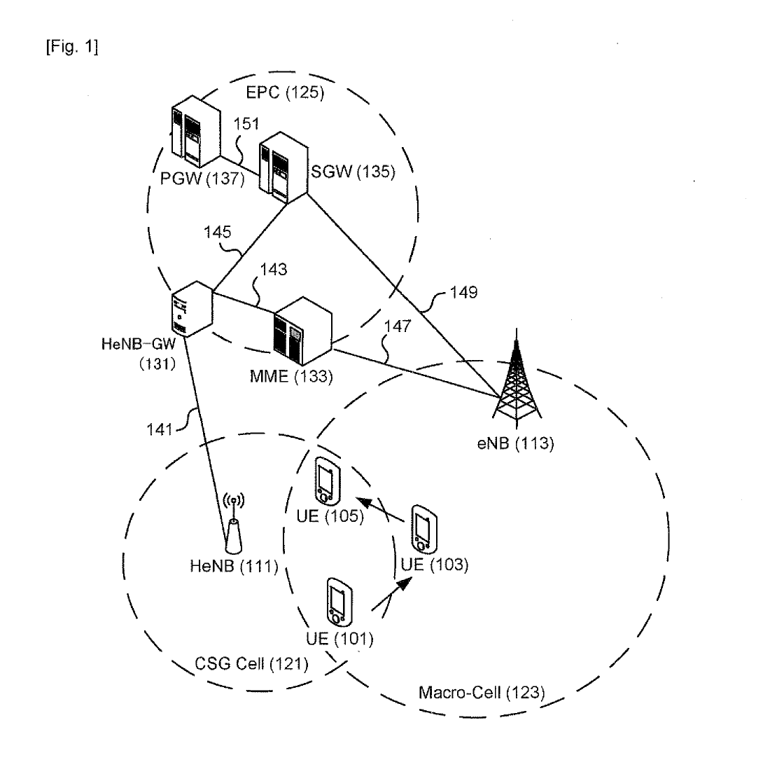

With reference to FIG. 1, a network configuration that the present invention can apply to is shown. As shown in the figure, the User Equipment (UE) at location 101 is originally connected to the mobile operator's core network, Evolved Packet Core (EPC) (125), via the Closed Subscriber Group (CSG) cell (121). More specifically, the UE (101) connects to the Home eNode B (HeNB) (111) via the Long Term Evolution (LTE) air interface; and the HeNB (111) connects to the EPC (125) through the HeNB Gateway (HeNB-GW) (131) via interface 141; and HeNB-GW (131) connects to the EPC (125) entities that serve the UE (101), e.g. Mobility Management Entity (MME) (133) via interface 143, and Serving Gateway (SGW) (135) via interface 145; the SGW (135) in turn connects to the Packet Data Network Gateway (PGW) (137) via interface 151. These EPC entities correspond to those defined in the Non-patent Document (General Packet Radio Service (CPRS) enhancements for Evolved Universal Terrestrial Radio Access Network (E-UTRAN) access, 3GPP TS23.401 v8.4.0 Release 8, 2008-12, http://www.3gpp.org/ftp/Specs/archive/23_series/23.401/23401-840.zip, hereinafter called 3GPP TS23.401 v8.4.0 Release 8), and the HeNB-GW (131) is an optional entity. When the HeNB-GW (131) does not exist, the interfaces 143 and 145 will terminate at the HeNB (111).

It is obvious to anyone skilled in the art that the interfaces used in the examples are for illustration purpose. The present invention can be applied with the same principle when alternative interfaces are used.

At certain point of time, the UE (101) will move out of the effective coverage of CSG cell (121) and enter the coverage of the Macro-cell (123), at position 103. The Macro-cell (123) is served by an eNode B (eNB) (113), which is connected to the EPC via interfaces 147 and 149 to MME (113) and SOW (135) respectively. It is obvious to anyone skilled in the art that even though the eNB (113) is shown to be connected to the same MME (133) and SGW (135) as the HeNB (111), this is not a requirement of the present invention. In a real deployment, there can be different or same MME and/or SGW for HeNB (111) and eNB (113), as long as the MMEs and SGWs have connectivity to each others.

After certain time, the UE will move back into the CSG cell (121) coverage at position 105, e.g. upon a notification shown to the user. It is obvious that during the movement, the expected user experience vary based on the active applications and connectives. For example if the UE is running a critical application, e.g. Voice over IP (VoIP) or online gaming, the user expects that the UE handovers to eNB (113) fast enough to keep the session, i.e. being less sticky to the CSG Cell (121). Whereas, if the UE is running a non-critical application, e.g. file downloading, or some CSG Cell (121) specific service, e.g. Local IP Access to the home based network, the user expects that the UE does not handover to eNB (113) at location 103 and resumes the connection to HeNB (111) soon after it goes back to location 105, i.e. being more sticky to the CSG Cell (121).

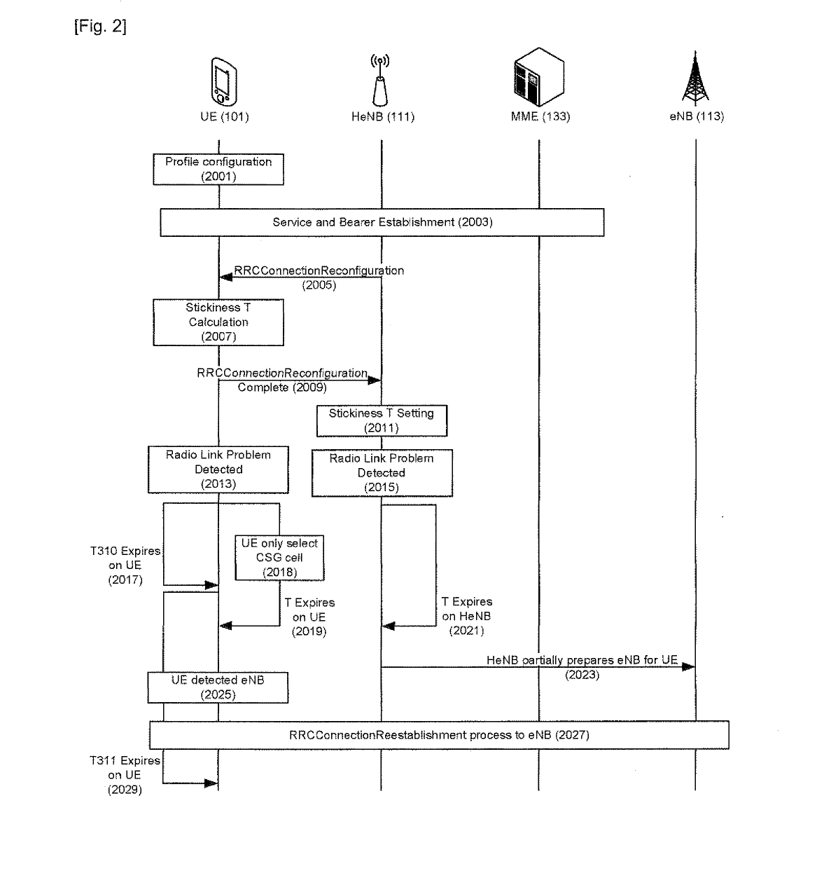

With reference to FIG. 2, an operation sequence of the present invention that achieves the above desired behavior is shown.

When UE (101) at the original location, it has its profile configured, as in step 2001. This could be done via a User Interface (UI) on the UE, or using program logic to derive from the application being activated on the UE. For example, a user can specify his/her preference via the UI to “no handover” to save cost, even though some VoIP application is activate.

If the user activates some application in the CSG cell (121), corresponding Service and Bearer Establishment process will be carried out, as in step 2003. This includes some Non-Access-Stratum (NAS) Signaling between UE (101) and MME (133), and some bearer management signaling between MME (133) and SGW (135) and HeNB (1), as specified in 3GPP TS23.401 v8.4.0 Release 8. After the successful network side operation, the HeNB (111) will inform the UE (101) via Radio Resource Control (RRC) signaling, as in step 2005, e.g. using the RRCConnectionReconfiguration message as specified in the Non-patent Document 3.

Once UE (101) received the RRCConnectionReconfiguration (2005), it will calculate the stickiness to the CSG Cell (121) based on the user preference set in step 2001 and the application and services activated so far. This stickiness calculation process will produce a value T, as in step 2007. There are different ways of deciding on the value of T, e.g. based on some pre-defined mapping between application and value T. After performed other operations as specified in the Non-patent Document 3 and 3GPP TS23.401 v8.4.0 Release 8, UE responds to HeNB (111) with an RRCConnectionReconfigurationComplete message, as in step 2009. Other than the normal elements specified in the Non-patent Document 3, this message also carries an additional information element indicating the T value. It is obvious to anyone skilled in the art that the T value can also be signaled to HeNB (111) using other messages, e.g. MeasurementReport, or a new dedicated RRC Handover Cancel (HO-Cancel) message, without affecting the general principle of the present invention.

Once received the RRCConnectionReconfigurationComplete (2009) with the T value, HeNB(111) stores it under the UE's stickiness setting, as in step 2011.

After certain time, UE (101) moves to location 103, which is out of the coverage of CSG Cell (121). Therefore, a radio link problem will be detected by the physical layer of the UE, as in step 2013. At the same time, a radio link problem will be detected on the corresponding HeNB (111), as in step 2015. It is obvious to anyone skilled in the art that there may be time difference for the UE (103) and HeNB (111) in detecting the radio link problem, depending on the access technologies used, i.e. step 2013 and 2015 do not happen at exactly the same time. However, this does not affect the generally principle of the invention. The time difference is sufficient small or can be compensated based on access technology characteristics, e.g. HeNB (111) uses a slightly smaller value for the Stickiness Timer than T indicated by the UE.

After detecting the radio link problem, as in step 2013, the UE (103) will start timer T310, as specified in the Non-patent Document 3, and Stickiness Timer T. Before the timer T310 expires, the UE (103) will try to recover the radio link, as specified in the Non-patent Document 3. During this period, the UE (103) will resume the connection without any signaling if physical layer recovery to the original CSG Cell (121) is detected. After the expiry of timer T310, as in step 2017, UE (103) will start timer T311, as specified in the Non-patent Document 3, as starts to perform cell selection.

Before the expiry of Stickiness Timer T, UE (103) will only consider the CSG Cell (121) in the cell selection process. Effectively, the UE (103) will ignore the detected Macro-Cell (123). This essentially prevents the UE (103) from trying re-establishment to the Macro-Cell (123) before it becomes prepared. It is obvious to anyone skilled in the art that the cells allowed to be selected during this period can be controlled by the UE (103) configurations, and is not limited to the original CSG Cell (121).

If the UE did not recover the connection or successfully re-establish the connection, after Stickiness Timer T expires at step 2019, UE is allowed to select any suitable cells for re-establishment.

On the HeNB (111), after Stickiness Timer T expires at step 2021, the HeNB (111) will perform a partial handover preparation for the UE towards the Macro-Cell eNB (113), as in step 2023. This partial handover includes sending the necessary context about the UE (101) to the eNB (113). This context information includes the information about the bearers, security context, e.g. KeNB* to derive the new KeNB, etc. This preparation process only includes the context transfer and may optionally include the pre-setup of bearers to the EPC. It is obvious to anyone skilled in the art that it does not change the general principle of the invention.

It is obvious that with the above operation, the eNB (113) is configured with the UE (103)'s context only if the UE (103) does not move back before Stickiness Timer T expires. Given a larger T, it would greatly reduce the unnecessary burden for the eNB (113).

If the UE (103) stays in the Macro-Cell (123) after the Stickiness Timer T expires, as in step 2019, the UE (103) starts to search for any suitable cell for re-establishment before the Timer T311 expires, as in 2029. At certain point, it will detect the eNB (113) of the Macro-Cell (123), as in step 2025. Upon the selection of the Macro-Cell, the UE (103) will start the RRCConnectionReestablishment process towards eNB (113) as in step 2027, as specified in the Non-patent Document 3. Since at this point of time eNB (113) is already prepared for the UE (103), the re-establishment process will be successful. UE (103) and the eNB (113) will then derive the necessary configurations, e.g. KeNB, and resume the communications.

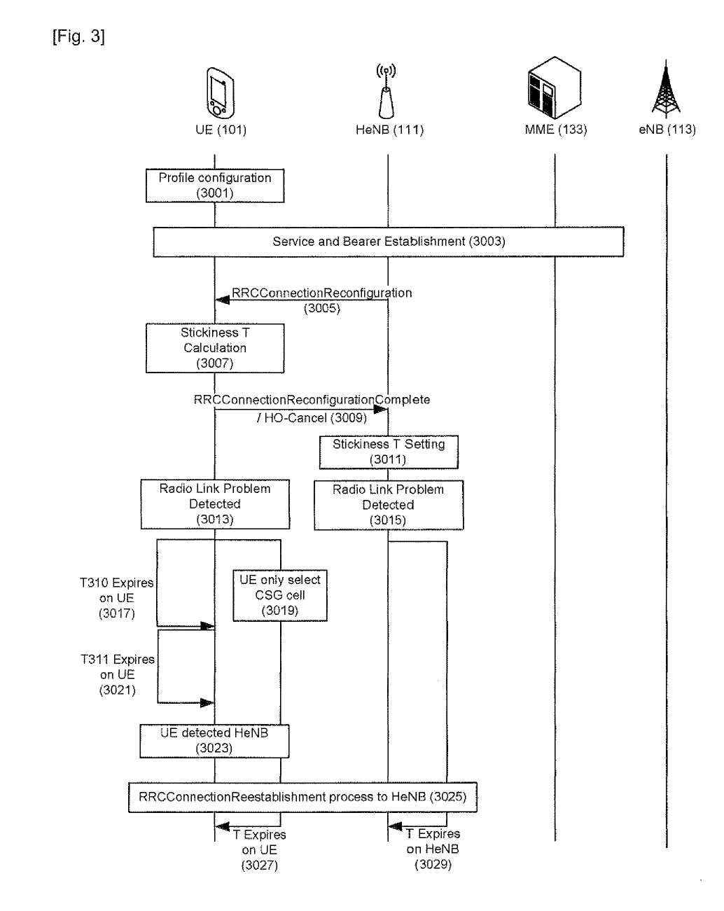

With reference to FIG. 3, an alternative operation sequence of the present invention is shown, wherein the UE (103) moves back into the CSG Cell (121) before the Stickiness Timer T expires.

As shown in FIG. 3, the operation step 3001 to 3005 is identical to that of the step 2001 to 2005 of FIG. 2. At step 3007, UE (101) calculates a Stickiness value T based on the user input at step 3001 and the active application requirements. In this example, the calculated T value is longer than T310 plus T311. It is obvious to anyone skilled in the art that the T value in this example is chosen for illustration purpose and does not limit the operation principle of the invention. The decided T value will be sent to HeNB (111) via a RRC message as in step 3009, e.g. the RRCConnectionReconfigureationComplete message or HO-Cancel message.

When UE (101) moves to location 103, both UE (103) and HeNB (111) will detect the radio link problem, as in step 3013 and step 3015 respectively. Therefore, UE (103) and HeNB (111) start the Stickiness Timer T. The UE (103) further starts the timer T310, and searches for the original CSG Cell (121) for physical layer recovery. If the physical layer recovery is detected before T310 expires, e.g. the UE (103) moves to location 105 in CSG Cell (121), the UE (105) will resume the connection with HeNB (111) without any further signaling.

Upon the expiry of timer T310 as in step 3017, UE (103) will start the timer T311 as specified in the Non-patent Document 3. Also, UE (103) starts to perform the cell selection process as specified in the Non-patent Document 4. However, if the Stickiness Timer T is still running on UE (103), as in this example, UE (103) will only select cells associated with the Stickiness Settings. Depends on the UE profile configuration, these cells can be cells of the same CSG ID as original CSG Cell (121), or cells of CSG ID of a pre-configured CSG ID list.

Upon the expiry of the timer T311, as in step 3021, the UE (103) checks if the Stickiness Timer. T is still running. If the T is still running, UE (103) continues the cell selection process. Otherwise, UE (103) goes to IDLE mode and informs NAS layer about the radio link failure.

Before the Stickiness Timer T expires, UE (103) moves to local 105 in the CSG Cell (121). Therefore, UE (105) will detect the CSG Cell (121), i.e. the HeNB (111), and select it according to the criteria as in step 3023. The UE (105) then performs the RRCConnectionReestablishment process as specified in the Non-patent Document 3 to HeNB (111), as in step 3025. This process will be successful, and UE (105) will continue the existing sessions.

It is obvious to anyone skilled in the art that, in the operations described above, only interactions that are crucial for illustrating the invention are presented. There are more interactions between the network entities, e.g. between MME (133) and HeNB (111) and eNB (113), between MME (133) and SGW (135), between HeNB (111) and HeNB-GW (131), etc. However these do not affect the general principle of invention.

### Embodiment 2

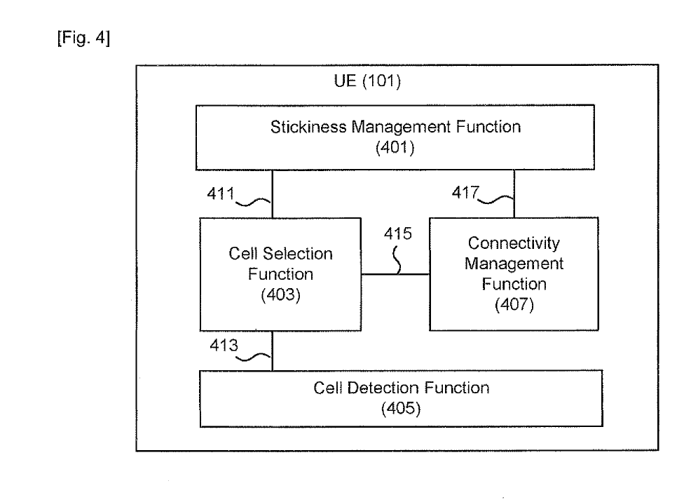

With reference to FIG. 4, an architecture of the UE (101) that implements the present invention is shown. It is obvious to anyone skilled in the art that only the components crucial for illustrating the present invention principle are shown. This does not prevent the UE (101) to include any additional components.

As presented in the figure, there are four major components, namely, the Stickiness Management Function (SMF) (401), Cell Selection Function (CSF) (403), Cell Detection Function (CDF) (405), and Connection Management Function (CMF) (407).

Among them, the SMF (401) is in charge of deriving the Stickiness Value T, storing and updating T based on the current profile and application, storing and managing the CSG IDs associated with the Stickiness Value, and starting and managing the Stickiness Timer upon trigger from CMF (407) via interface 417. The SMF (401) interacts with CSF (403) via interface 411, and provides the CSF of the Stickiness Timer T status and the CSG IDs associated with the Stickiness Timer T.

The CSF (403) is in charge of performing the cell selection function as specified in the Non-patent Document 4. It makes use of the detected cell information provided by the CDF (405) via interface 413. At the same time, if the Stickiness Timer T is running, CSF (403) also takes the CSG IDs provided by SMF (401) into account. The selected cell information will be provided to the CMF (407) via interface 415 for connection re-establishment operation as specified in the Non-patent Document 3.

The CMF (407) is in charge of monitoring and managing the UE (101)'s connectivity to the HeNB (111) or eNB (113). This includes, for example, detecting the radio link problem, starting and managing Timer T310 and T311 when appropriate, triggering SMF (401) for Stickiness Timer management, performing re-establishment of link to HeNB (111) or eNB (113) using cell information provided by CSF (403).

The CDF (405) is in charge of detecting the cells present to the UE (101)'s current location. The CDF (405) informs the CSF (403) of any detected cell and relevant information via interface 413.

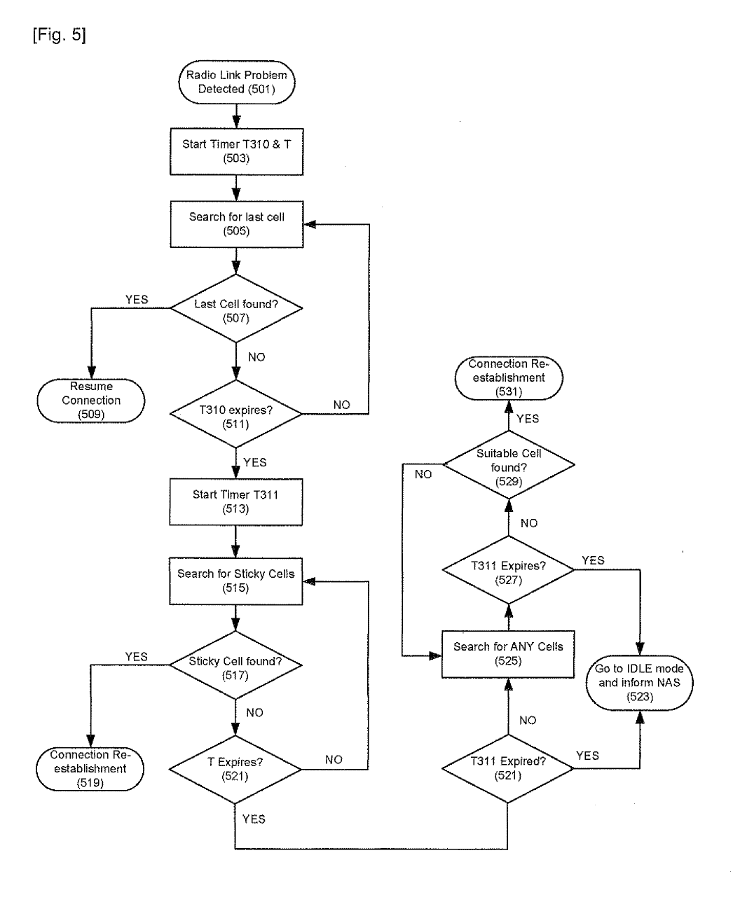

With reference to FIG. 5, an example logic that is used by the UE (101) to implement the present invention is shown. It is obvious to anyone skilled in the art that this logic only represents part of the interaction between the four components of the UE (103) after a radio link problem is detected.

As shown in FIG. 5, the UE (103)'s CMF (407) will detect a radio link problem as in step 501. Upon this detection, CMF (407) starts the Timer T310, and also trigger the SMF (401) to start the Stickiness Timer T, as in step 503. At the same time, CMF (407) will instruct the lower layer to search for the original CSG Cell (121), as in step 505. If the last CSG Cell (121) is detected, as decided in step 507, the CMF (407) will resume the connection as specified in the Non-patent Document 3, as in step 509.

The UE (103) will continue to search for the last CSG Cell (121), as long as the Timer T310 is active, as decided in step 511, and the Last CSG Cell (121) is not yet detected, as decided in step 507.

When the Timer T310 expires, as decided in step 511, the CMF (407) starts the Timer T311, as in step 513. At the same time, the CMF (407) instruct the CSF (403) to search for the Sticky Cells. The CSF (403) obtains the Sticky Cells criteria from the SMF (401). The CSF (403) obtains the detected cell information from the CDF (405).

When a Sticky Cell according to the criteria is found, as in step 517, the CSF (403) informs the CMF (407), which in turn perform the RRCConnectionReestablishment process as specified in the Non-patent Document 3, as in step 519.

As long as Stickiness Timer T is running, the CSF (403) will continue to search for the Sticky Cell until one is found.

When the SMF (401) detects the expiry of the Stickiness Timer T, it removes the Sticky Cells Criteria from the CSF (403), and informs the CMF (407) about the expiry. The CMF (407) will check if the timer T311 is still running, as in step 521. If the timer T311 has already expired, the CMF (407) will inform the RRC layer to go to IDLE mode, and inform the NAS layer about the radio link failure as in step 523.

If the timer T311 is still running, the CMF (407) instruct the CSF (403) to continue the cell selection function that allows any suitable cells, not limited to Sticky Cells, as in step 525. The CSF (403) will perform this action until the CMF (407) detects the expiry of T311 or a suitable cell is found. If the T311 expires, the CMF (407) stops the CSF (403), informs the RRC to go to IDLE mode, and informs the NAS layer about the radio link failure, as in step 523.

If a suitable cell is selected by the CSF (403) before T311 expires, as decided in step 529, the CSF (403) informs the CMF (407) about the cell. The CMF (407) in turn performs the RRCConnectionReestablishment process as specified in the Non-patent Document 3 to this cell, as in step 531.

It is obvious to anyone skilled in the art that the above logic is for the illustration purpose. The UE (103) can employ other logic with the same principle. Furthermore, it is obvious to anyone skilled in the art that the Timer T can start running at a certain time such as at the same time of starting the Timer T311, though the Timer T starts running at the same time of starting the Timer T310 in the above operation. When the Timer T starts at the timing between T310 and T311, there are some timing phases, for example phase1: the start of T310 to the start of T, phase2: the start of T to the end of T310, phase3: the start of T311 to the end of T or the start of T311 to the end of T311, and phase4: the end of T to the end of T311 or the end of T311 to the end of T. Then UE can change the Sticky Cells Criteria in each timing phase.

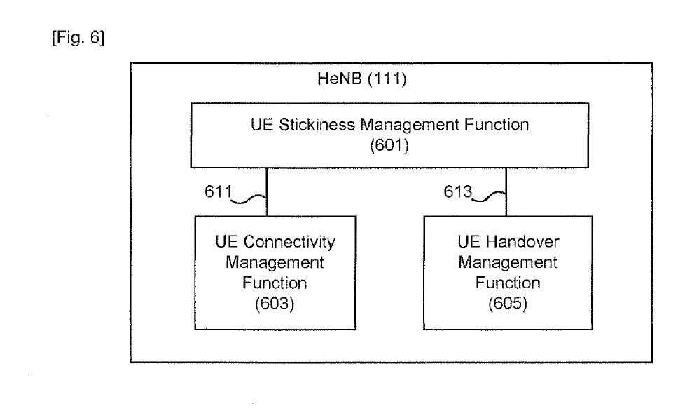

With reference to FIG. 6, an example architecture of the HeNB (111) that implements the present invention is shown. It is obvious to anyone skilled in the art that only components crucial for the operation of the invention are shown. In a real implementation, the HeNB (111) may have other components.

As shown in FIG. 6, there are three major components in the HeNB (111) that are relevant to the invention operation. Namely, they are the UE Stickiness Management Function (USMF) (601), UE Connectivity Management Function (UCMF) (603), and the UE Handover Management Function (UHMF) (605).

Among them, the USMF (601) is in charge of storing and managing the value of the Stickiness Value T corresponds to the UE, starting and stopping the Stickiness Timer T for the UE, triggering UHMF (605) via interface 613 to perform partial handover preparation to a list of pre-defined cells upon expiry of timer T.

The UCMF (603) is in charge of monitoring and managing the connectivity to the UE. Upon detection of any radio link problem or the recovery at physical layer, the UCMF (603) informs the USMF (601) via interface 611 to start or stop Stickiness Timer T accordingly.

The UHMF (605) is in charge of the handover preparation for the UE upon the trigger from USMF (601) form interface 613, e.g. transferring UE context to an eNB or another HeNB.

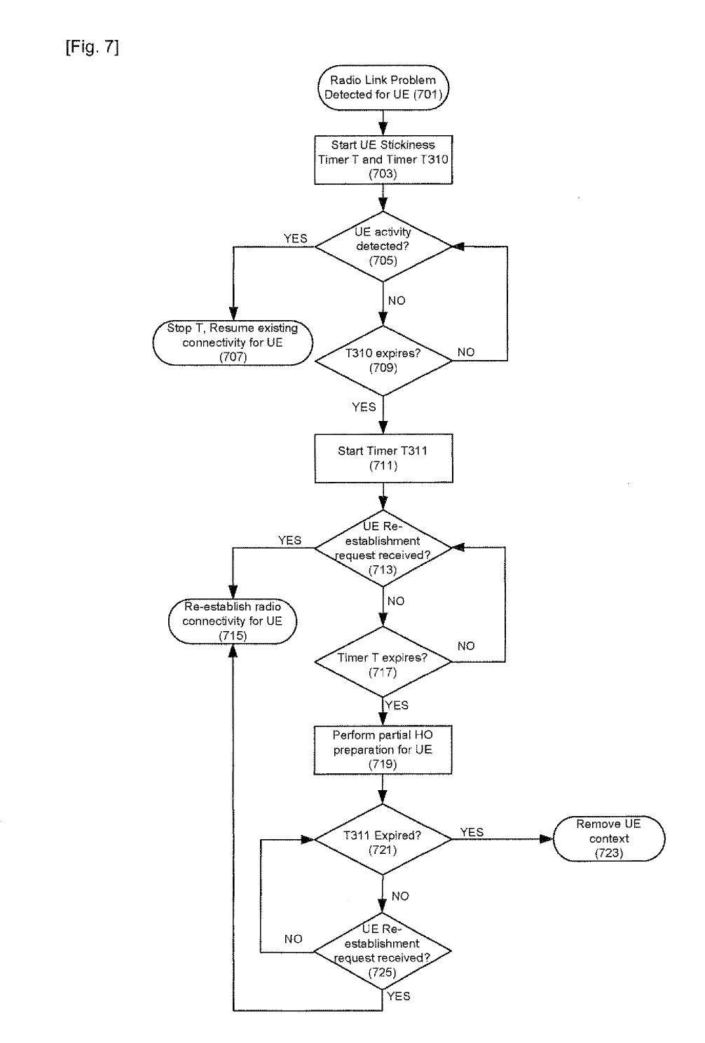

With reference to FIG. 7, an operation logic that can be used by the HeNB (111) implementing the present invention is shown. It is obvious to anyone skilled in the art that this logic only represents the operation the HeNB (111) takes after detected a radio link problem with the UE by UCMF (603).

As shown in the figure, upon detection of the radio link problem for the UE (101) by the UCMF (603), the UCMF (603) will start the Timer T310, and inform the USMF (601) to start Stickiness Timer T via interface 611, as in step 703.

Before the expiry of timer T310, if the UE (101)'s activity is detected at the HeNB (111), the UCMF (603) will inform the USMF (601) to stop the Stickiness Timer T, and resume the connection with UE (101), as in step 707. If by expiry of timer T310 no UE (101) activity is detected, the UCMF (603) will start the timer T311, as in step 711.

The UCMF (603) will then monitor if there is any RRCReconnectionReestablishmentRequest from the UE (101), as in step 713. If such a request is received before the expiry of Stickiness Timer T, UCMF (603) will inform the USMF (601) to stop the timer T and Re-establish the connectivity with UE as specified in the Non-patent Document 3, as in step 715.

If no request is received by the expiry of Stickiness Timer T, the USMF (601) will trigger the UHMF (605) to carry out the Handover Preparation operation, as in step 719. This includes sending the UE's context, including the security keys, to the pre-defined set of cells, e.g. eNB (113).

The UCMF (603) will continue to monitor for the UE (101)'s RRCReconnectionReestablishmentRequest until the expiry of timer T311, as in step 721. If such a request is received, the UCMF (603) stops the timer T311 and carries out the RRCReconnectionReestablishment process, as specified in the Non-patent Document 3, as in step 715. Upon the expiry of timer T311, the UCMF (603) will proceed to remove the context about the UE from its storage, as in step 723.

It is obvious to anyone skilled in the art that the Timer T can start running at a certain time such as at the same time of starting the Timer T311, though the Timer T starts running at the same time of starting the Timer T310 in the above operation. When the Timer T starts at a time between T310 and T311, there are some timing phases, for example phase1: the start of T310 to the start of T, phase2: the start of T to the end of T310, phase3: the start of T311 to the end of T or the start of T311 to the end of T311, and phase4: the end of T to the end of T311 or the end of T311 to the end of T. Then UE can change the Sticky Cells Criteria in each timing phase.

### Embodiment 3

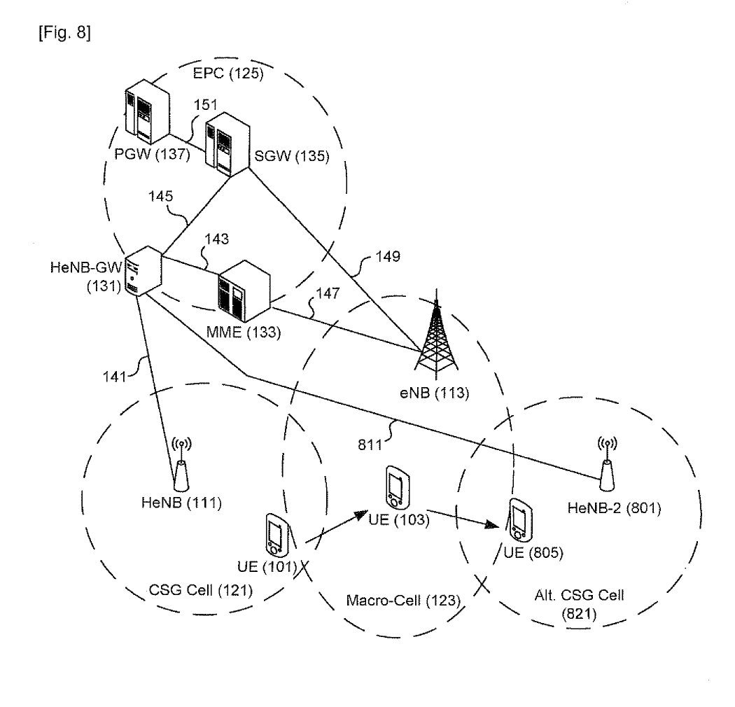

The present invention is also applicable to a network configuration that has multiple CSG cells, e.g. the corporate network deployment. With reference to FIG. 8, such a network configuration is depicted.

As shown in FIG. 8, there are two CSG cells, i.e. CSG Cell (121) and Alternative CSG Cell (821). The connectivity of CSG Cell (121) to the EPC (125) is identical to that of the FIG. 1. The Alternative CSG Cell (821) is provided by the HeNB-2 (801), which is connected to the EPC through HeNB-GW (131) via interface 811. An example of the real deployment of this configuration is the corporate network where different HeNBs of the same CSG ID are installed at locations of close distance, e.g. one in the lift lobby and another in the canteen. The coverage of the two CSG cells is not overlapping, but sufficiently close. Therefore, for a corporate employee accessing internal services would prefer not handover to the Macro-Cell (123) when he/she walks from one location toward another, e.g. as shown in FIG. 8, UE moves from location 101 in the coverage of CSG Cell (121) to the location 103 in the coverage of Macro Cell (123), and then moves to the location 805 in the coverage of Alternative CSG Cell (821).

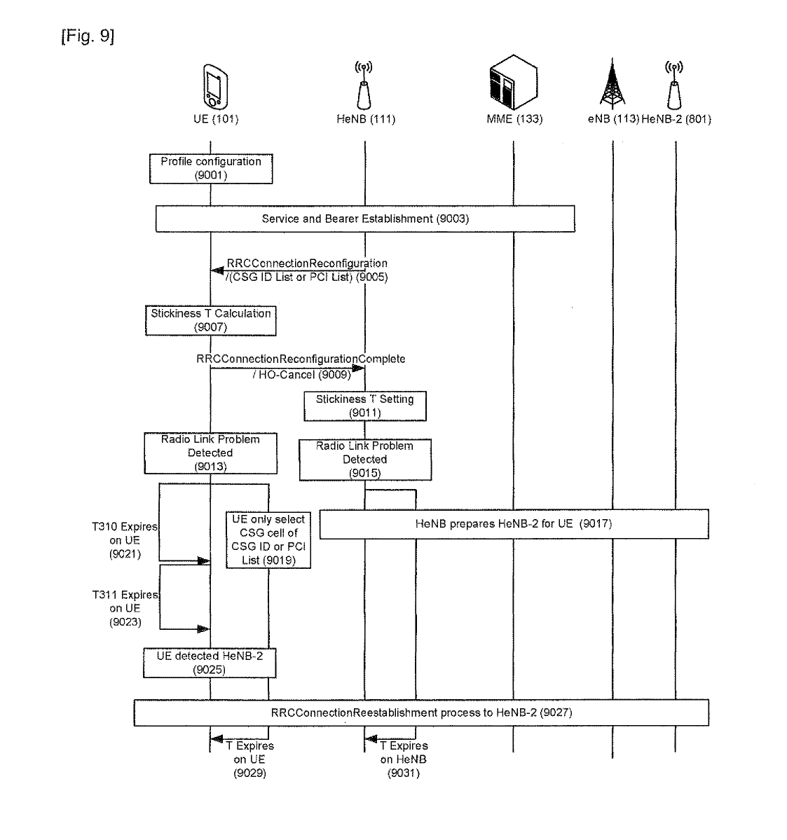

With reference to FIG. 9, an example operation sequence of the present invention applied in the network of FIG. 8 is shown. The step 9001 to step 9003 are identical to the step 3001 to step 3003 of the operation sequence shown in FIG. 3.

At step 9005, when the HeNB (111) sends the RRCConnectionReconfiguration message to the UE (101), it may include the criteria for the Sticky Cells selection. This could be for example a list of CSG IDs or a list of PCIs or ECGIs. The criteria are to be used by CSF (403) of UE (101) to select the Sticky Cell. It means any cell matching the criteria should be treated as the Sticky Cell. It is obvious to anyone skilled in the art that the Sticky Cell Criteria could be also sent to the UE (101) via other means, e.g. in the broadcasted System Information Block (SIB).

Step 9007 to step 9015 are identical to that of step 3007 to step 3015 of FIG. 3.

After the radio link problem detection for the UE at HeNB (111), the HeNB (111) will prepare for the UE all the cells that meet the Sticky Cell Criteria, as in step 9017. Therefore, in the following operation, if the UE (805) detects the HeNB-2 (801) that meets the Sticky Cell Criteria, as in step 9025, the UE (805) will try to perform the RRCConnectionRestablishment process to the HeNB-2 (801), as in step 9027.

Upon a successful connection re-establishment at the HeNB-2 (801) with the UE (805), the HeNB-2 (801) will inform the original HeNB (111) of the connection of UE (805), e.g. as part of the backend process of the Re-establishment process, as in step 9027. This will cause the original HeNB (111) to stop the Stickiness Timer T, and cancel any potential Handover Preparation process towards other cells, e.g. Macro-Cell (123).

The Sticky Cell Criteria that is stored on the HeNB (111) can be obtained by different means. For example, it can be pre-configured by the HeNB operator via O&M interface, or it could be generated dynamically via some protocols running between the Sticky Cells.

### Embodiment 4

In the UE (101), a Stickiness Value T is calculated by the SMF (401), and later used for managing the cell selection. There are different methods for the calculation of the value T.

For example, the T can be obtained by checking the type of active application against a mapping table stored in the UE or the USIM component. For example, if a VoIP application is running, the T should be 3 second, and if a file downloading application is running, T should be 20 second, etc. If there are multiple applications running, the shortest T among all the applications' should be adopted. The table may also have entries for turning off the stickiness mechanism for certain critical applications, e.g. with the T value equals to zero. The Stickiness Value Mapping Table could be a standardized set that is pre-configured in the UE, or an operator specific set that is stored in the USIM, or a CSG cell specific set that is broadcasted by the HeNB (111).

The UE (101) also can provide a User Interface (UI) to allow user input to assist the decision of value T. For example, the user may enter a specific T that is very long if he/she wants to minimize any handover. Or, the user may turn off the stickiness mechanism if he/she feels that no service interruption is tolerable. The user entered value may override the value obtained by the mapping described above.

The T value can also be derived based on other criteria, e.g. the PDN type. For example, if the UE has a PDN connection for accessing the Local IP Access that is restricted only to the current CSG cell, it makes no sense to handover out to the Macro-Cell. In this case, a very large T value should be adopted.

Another method for deriving the value T is based on the QoS requirement of the different bearers. For example, for each of the SAE bearer, there will be a QoS Class Identifier (QCI) associated. Based on this QCI, the corresponding value T can be derived on the HeNB and UE respectively (with same outcome). In this case, no signaling for setting the T on HeNB (111) is necessary.

The stickiness value T can also be decided based on the type of CSG cells the UE is connected to. For example, the UE (101) can keep a list of T settings corresponds to different groups, e.g. 60 seconds for “Most preferred”, 30 seconds for “Preferred”, and 10 seconds for “Normal”. The UE also keeps a list of the CSG IDs or Cell IDs that are tagged with the groups. For example, the CSG ID of “home.of.John.Doe” is tagged as “Most preferred”. In this case, if the current CSG cell is of the CSG ID “home.of.John.Doe”, corresponding T settings, i.e. 60 seconds, would be used.

The stickiness value T can also be decided based on the UE (101)'s membership status to the CSG. For example, if the UE (101) is a gold member of the CSG, it may receive preferential treatment, and therefore, should use a stickiness value T that matches the “Most preferred” group. If the UE (101) is a normal member of the CSG, it may need to use only the T value that matches the group “Preferred” group.

In case the HeNB (111) is operating in hybrid mode, UE (101) will use different T settings depends on whether it is accessing as a public member or CSG member. When the UE (101) does not have any subscription to the CSG, i.e. does not have the corresponding CSG ID in its Allowed CSG List, it can obtain access to the HeNB (111) as a public member. The HeNB (111) would be informed by the core network entity, e.g. MME (133), about the UE (101)'s membership status, via the S1 interface. Alternatively, the lack of such information from the MME (133) can indicate that the UE (101) is accessing as a public member. On the other hand, the UE (101) knows whether it is accessing as a public member or private member based on the stored Allowed CSG List.

The HeNB (111) may give less preferential treatment to the UE (101) that is accessing as the public member. Therefore, the UE (101) may want to reduce its stickiness to the CSG cell, i.e. to use a different set of T value. UE (101) makes such decision on the value of T at step 2007 or 3007, and inform the HeNB (111) about the selected value T at step 2009 or 3009.

Alternatively, the HeNB (111), knowing the membership status of the UE (101), may also adjust the stickiness setting for the UE (101). For example, at step 2005 or 3005, the HeNB (111) can inform UE (101) of the proper stickiness value to use, derived based on the UE (101)'s membership status.

In certain cases, a CSG cell is not in the UE (101)'s Allowed CSG List. UE (101) may choose to use manual selection approach to obtain access to such cell. This may happen in a few scenarios, e.g. the network has not update the UE (101)'s Allowed CSG List of a new CSG, the operator does not deploy other management protocol to update the Allowed CSG List, etc. When this manual selection procedure results in successful access, the UE (101) should use the same or even higher stickiness as the cells in the Allowed CSG List.

In case the UE (101) applies manual selection in a hybrid CSG cell, a successful connection setup does not indicate if it is accessing as a public member or a private. In this case, UE (101) may apply the stickiness value as if it is a public member, unless there are other indications, e.g. in the return NAS message, RRC Connection Reconfiguration message, etc.

The value T may change based on the user input and application/bearer status. Therefore, in certain case, the UE (101) needs to update the T stored in HeNB (111), e.g. user changed the profile configuration. To achieve this purpose the UE (101) can include a new T piggybacked in a RRC message to the HeNB (111), e.g. the MeasurementReport message.

### Embodiment 5

The CSF (403) function of the UE (101) generally follows the operation specified in the Non-patent Document 4, with the Stickiness Cell Criteria applied. However, if the best cell principle is followed closely by CSF (403), some CSG cells will not appear to be detected if other cells are having much stronger signals. Therefore, in order to keep the best cell principle in the cell selection process, it is possible to apply certain OffSet value for all the Sticky Cells. This OffSet can be a pre-configured value or obtained together with the Sticky Cell Criteria, e.g. from the HeNB in step 2005, 3005, or 9005.

Similar to the above described stickiness value T management, a UE (101) may also have different OffSet values for different CSG cells. These can also be tagged with different groups of the CSGs.

Similarly, the different OffSet values may also be used based on the membership status of the UE (101) to the CSG. Especially, for the hybrid CSG cell, the OffSet may only be used if the UE (101) is accessing as a CSG member.

### Embodiment 6

In the previous description, the Stickiness Value T are transported from UE (101) to

HeNB (111) piggybacked on some existing RRC messages, e.g. the RRCConnectionReconfigurationComplete, or MeasurementReport. However, it is also possible in the implementation to specify a new RRC message, e.g. HO-Cancel, for this purpose, i.e. to inform HeNB (111) of the selected Stickiness Value T and UE (101)'s preference for stick to the CSG cell. The use of a separate HO-Cancel message provides better extensibility. For example, it can be utilized in the Macro-Cell (123) as an indicator to the eNB (113) to adopt the Event Driven Handover Procedure, etc.

### Embodiment 7

In the above described operations, the UE (101) and HeNB (111) start the Stickiness Timer T as soon as a radio link problem is detected, i.e. start the Stickiness Timer T and T310 at the same time. However, in implementation, it is also possible to start the Stickiness Timer after the timer T310 expiry. In this case, the Stickiness Timer can for example be started together with the timer T311.

With this new behavior, most of the processing sequence and logic described earlier still apply, except for the step of starting the timers. However, the Stickiness Value T may be adjusted accordingly, i.e. to consider the value of timer T310.

On the HeNB (111) side, the Stickiness Timer can still be initiated when the radio link problem is detected, i.e. the same operation as described earlier is kept. In this case, the HeNB (111) will start to prepare the other cells ahead of the expiry of Stickiness Timer T on. UE (101), and the time difference is the value of timer T310. This may be also a desired behavior, as it can guarantee that the other cells are prepared at the time Stickiness Timer T expires on UE (101).

It is obvious to anyone skilled in the art that the above variance does not change the general principle of the present invention.

Each functional block used in the description of the embodiments as given above can be realized as LSI, typically represented by the integrated circuit. These may be produced as one chip individually or may be designed as one chip to include a part or all. Here, it is referred as LSI, while it may be called IC, system LSI, super LSI, or ultra LSI, depending on the degree of integration. Also, the technique of integrated circuit is not limited only to LSI and it may be realized as a dedicated circuit or a general-purpose processor. FPGA (Field Programmable Gate Array), which can be programmed after the manufacture of LSI, or a reconfigurable processor, in which connection or setting of circuit cell inside LSI can be reconfigured, may be used. Further, with the progress of semiconductor technique or other techniques derived from it, when the technique of circuit integration to replace LSI may emerge, the functional blocks may be integrated by using such technique. For example, the adaptation of bio-technology is one of such possibilities.

### INDUSTRIAL APPLICABILITY

This invention has the advantage of avoiding connection re-establishment failure while maximizing the UE's stickiness to the CSG cell, and also has the advantage of deciding the proper stickiness of the CSG cell based on user preference and application requirements. Therefore, this invention can be applied to the technology of data communications network, more specifically the technology of the handover control for the mobile terminal in a mobile communication system.

1-16. (canceled)

17. A communication terminal having a connection to a Home eNodeB (HeNB) in a Closed Subscriber Group (CSG) cell, the communication terminal comprising:
a radio link monitor unit that detects a radio link problem that the connection to the HeNB is likely to be lost;
a timer manager that starts a timer when the radio link monitor unit detects the radio link problem;
a cell detection unit that searches available cells; and a cell selection unit that selects a target cell among the available cells; and
wherein the cell selection unit selects the target cell out of only CSG cells before the timer expires, and tries to re-establish a connection to a HeNB in the target CSG cell.

18. The communication terminal according to claim 17, further comprising;
a timer produce unit that calculates a time period of the timer based on active application and user input.

19. The communication terminal according to claim 17, further comprising an inform unit that informs the timer to the HeNB in the CSG cell.

20. The communication terminal according to claim 17, wherein the HeNB in the CSG cell only performs partial Handover preparation to a cell different from the HeNB in the CSG cell after the timer expires.

21. The communication terminal according to claim 17, wherein the cell selection unit receives a message including a criteria for selecting the target cell from the HeNB in the CSG cell.

22. The communication terminal according to claim 21, wherein the criteria is a list of CSG IDs and multiple CSG cells can be identified by one or more CSG IDs or specific Cell IDs.

23. The communication terminal according to claim 18, wherein the timer can be derived based on Packet Data Network (PDN) type.

24. The communication terminal according to claim 18, wherein the timer can be derived on the communication terminal and the HeNB individually without requiring any signaling.

25. The communication terminal according to claim 18, wherein derivation of the timer is controlled by an operator with information stored in Universal Subscriber Identification Module (USIM).

26. The communication terminal according to claim 18, wherein derivation of the timer is controlled per the CSG cell with information broadcasted in the CSG cell.

27. The communication terminal according to claim 18, wherein the time period of the timer is decided on identification of the CSG cell.

28. The communication terminal according to claim 18, wherein the time period of the timer is decided based on membership status of the communication terminal in the CSG cell.

29. The communication terminal according to claim 18, wherein the time period of the timer is decided based on a method of obtaining an access by the communication terminal.

30. The communication terminal according to claim 17, wherein the timer is indicated by a network to the communication terminal.

31. A communication system enabling a communication terminal to handover between a Closed Subscriber Group (CSG) cell and a macro cell, the system comprising:
a communication terminal having a connection to a Home eNodeB (HeNB) in the CSG cell that comprises,
a radio link monitor unit that detects a radio link problem that the connection between the HeNB and the communication terminal is likely to be lost;
a timer manager that starts a timer when the radio link monitor unit detects the radio link problem;
a cell detection unit that searches available cells; and
a cell selection unit that selects a target cell among the available cells; and
the HeNB in the CSG cell that comprises,
a timer manager that starts the timer when the radio link problem is detected;
a connection manager that detects the radio link problem, and manages the connection between the communication terminal and the HeNB; and
a handover manager that performs partial handover preparation to the macro cell after the timer expires; and
wherein the cell selection unit in the communication terminal selects the target cell out of only CSG cells before the timer expires, and tries to re-establish a connection to a HeNB in the target CSG cell.

32. A method used for a communication terminal having a connection to a Home eNodeB (HeNB) in a Closed Subscriber Group (CSG) cell, the method comprising:
a radio link monitoring step that detects a radio link problem that the connection to the HeNB is likely to be lost;
a timer starting step that starts a timer when detecting the radio link problem;
a cell detecting step that searches available cells; and a cell selecting step that selects a target cell among the available cells; and
wherein the cell selecting step selects the target cell out of only CSG cells before the timer expires, and tries to re-establish a connection to a HeNB in the target CSG cell.
